(19) United States
(12) Patent Application Publication
(10) Pub. No.: US 2007/0067818 A1
(43) Pub. Date: Mar. 22, 2007

(54) Means and method for mobile television

(75) Inventor: Johan Hjelm, Stockholm (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (publ), Stockholm (SE)

(21) Appl. No.: 11/230,923

(22) Filed: Sep. 21, 2005

(51) Int. Cl. H04N 7/173; H04M 1/00

(52) U.S. Cl. 725/110; 455/556.1

(57) ABSTRACT

A method for selecting television content in mobile television communications is provided. Descriptions of predefined possible video sequences (112) is transmitted from a video system (110) to a selection server (120). The selection server collects information on user preferences with regard to video, e.g. from a user profile holding unit (140). User preference information may also be expressed through user votes in a voting process related to the television event. The selection server uses the descriptions of the alternative video sequences and the user preference information to determine an output video sequence for at least one mobile terminal (130) in the communication system. The video output system is instructed to output the determined television content.

### TECHNICAL FIELD

The present invention relates to digital communication and mobile television systems.

### BACKGROUND

In recent years, the interest in services and technologies that will enable real-time television (TV) to be sent to mobile devices has grown explosively. Mobile TV generally refers to the sending of continuous TV feeds to handheld devices, offering users services they can access at any time. This can be done by satellite, through the terrestrial digital TV network, or via mobile networks.

Previously, mobile TV services via the mobile networks had to rely on unicast transmission, with one stream for each viewer. Such point-to-point communication consumes a large amount of bandwidth and requires careful network balancing considerations. However, a recent technology referred to as Multimedia Broadcast and Multicast Services (MBMS) [1] contributes to overcoming these network capacity problems and takes mobile TV services beyond unicast.

MBMS is a point-to-multipoint technology, sending a single stream to multiple viewers simultaneously. It simplifies simultaneous delivery of content to multiple destinations and is very advantageous from the network perspective, by replicating data at appropriate points in the network rather than in the end systems. Hence, MBMS facilitates the integration of broadcast and multicast transmission into the mobile network infrastructure, saving bandwidth resources and offering a higher quality TV at a lower cost.

With MBMS, data is sent to multicast groups, each associated with a group address. This enables new kinds of services, principally content subscription services. Moreover, MBMS includes an uplink channel, which opens up the possibility for user interaction. Nevertheless, in order to make use of these advantageous features and improve the mobile TV services, more sophisticated delivery mechanisms will be needed. In particular, it would be desirable to be able to offer more personalized services.

### SUMMARY

A general object of the present invention is to provide an improved method for mobile television communication. A specific object is to achieve an improved method for determining the content of television for mobile devices. Another object is to enable personalized services for mobile TV. Still another object is to provide a mechanism for mobile TV that is user-friendly and easy to implement.

These objects are achieved in accordance with the attached claims.

Briefly, the present invention proposes a method for selecting television content in a digital mobile television communication system so as to reflect the preferences of individual users or groups of users. A selection server retrieves descriptions of possible video sequences related to a particular television event as well as information about user preferences with regard to television. Based on these descriptions and preferences the selection server determines what television content that should be output and instructs the video (production and broadcast) system accordingly. The descriptions are preferably mapped to a semantic web technology, whereby the television selection in the network can be performed in an automated manner, such that the network determines what television that is to be displayed. The user preferences are preferably also mapped to the semantic web technology.

The proposed solution allows users to actively influence the television content. The users may choose between and combine video sequences that are predefined, i.e. recorded or filmed in advance, and can interactively influence the main stream/sequence as well as select television content of sub-streams/sub-sequences (e.g. streams displayed during advertising breaks).

The selection of TV content is preferably such that the selection server determines an output video sequence for at least one individual mobile terminal, or group of terminals, whereby display of different video sequences at different terminals is possible. Accordingly, the video output system may receive instructions to output parallel flows of video sequences, a first output video sequence being transmitted to a first mobile terminal and a second output video sequence being transmitted to a second mobile terminal.

According to some particular advantageous embodiments, mechanisms for determining the main video stream by voting and for assigning users to multicast groups according to their television preferences, respectively, are included to improve the mobile television service further.

In accordance with other aspects of the invention, a selection server, and a digital mobile television communication system with means for selecting television content are provided.

### BRIEF DESCRIPTION OF THE DRAWINGS

The invention, together with further objects and advantages thereof, may best be understood by reference to the following description taken together with the accompanying drawings, in which:

FIG. 1 is a schematic overview of a network for mobile television communication in accordance with an exemplary embodiment of the present invention;

FIG. 2 is a schematic overview of a network for mobile television communication with voting in accordance with another exemplary embodiment of the present invention;

FIG. 3 is a schematic overview of a multicast network for mobile television communication in accordance with still another exemplary embodiment of the present invention;

FIG. 4 is a schematic block diagram illustrating a selection server in accordance with an exemplary embodiment of the present invention; and

FIG. 5 is a flow chart of a method for selecting television content according to an exemplary embodiment of the present invention.

### DETAILED DESCRIPTION

For the purpose of this disclosure, a “video/television sequence” refers to a pre-recorded sequence in a format suitable for broadcast. A “television sequence” generally consists of a number of “video sequences”, i.e. a television sequence is a sequence of video sequences. In this disclosure the terms are often used in an synonymous or interchangeable manner.

The term “output video sequence” is here used for video sequences that are output from a video (television) output system. The output video sequence may be addressed to one or more particular terminals or groups of terminals, or broadcast to an unspecified number of receiving terminals. Finally, “main sequence” refers to the video/television sequence that is broadcast to receivers which have not subscribed to the service or which have not chosen and received another sequence. The main sequence corresponds to the “ordinary” television content of previous, “non-personalized” television systems and it is often the main sequence that sets the course of events.

The present invention provides a new mechanism for selecting television content in a digital mobile television system. Personalized television services are enabled by means of a selection server in the network. The selection server is adapted for processing video sequence descriptions and user preference information in order to determine the content of the television output in a way that will now be described with reference to a number of exemplary embodiments.

Personalized TV Service and Parallel Flows

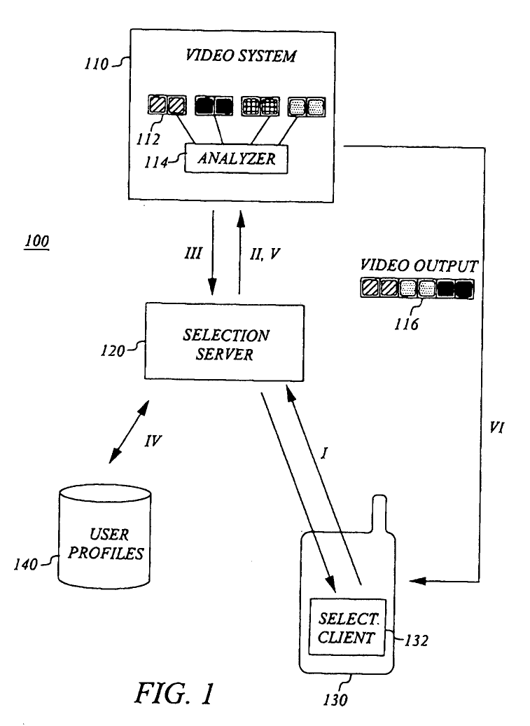

FIG. 1 is a schematic overview of an exemplary network for mobile television communication in accordance with an exemplary embodiment of the present invention. The illustrated network 100 comprises a video system 110, a selection server 120, a mobile terminal 130 and a user profile holding unit 140. The video system 110 normally contains equipment for television production and broadcasting and hosts a number of predefined video sequences 112, at least a subset of which being optional or alternative with respect to each other. There are means 114 for analyzing and handling the video sequences 112 included in the illustrated video system. The video system 110 is arranged to output video streams 116 to the mobile terminals 130 in the network 100.

The video output 116, i.e. the television content, is determined by the selection server 120, which preferably generates and communicates with a selection client 132 in the mobile terminal 130. Upon user activation (I), the selection server 120 sends a request for television content to the video system 110 (II). It should be noted that users do not have to pre-register to participate. The service can for example be activated by the user when he wants to select TV content or by a user response to a notification from the network. The video system 110 responds to the request by returning information about the video sequences that relates to the television event (show, program, etc.) of the request (III). This means that descriptions of a number of alternative video sequences, which are predefined and related to the same television event, are transmitted from the video system 110 to the selection server 120. The actual video sequences normally remain at the video system, though. There may for example be alternative video sequences relating to different course of events, different camera angles, alternative or optional television content (such as advertising vs. additional action), etc.

The selection server 120 also collects information on user preferences with regard to television of those utilizing the service (IV). In FIG. 1, this information is retrieved from the user profile holding unit 140 of the network 100. A person skilled in the art recognizes that there are a number of ways of storing or otherwise handling user preference information and that the information may be contained within the system or in an external database. The preferences can also be brought to the knowledge of the selection server through direct communication with the mobile terminal 130 upon request or through other actions or choices by the user.

Having access to information about possible video sequences as well as information about which video sequence(s) or what kind of television content the user prefers, the selection server 120 determines an output video sequence for the mobile terminal 130 of the user. Hereby, the selection server typically compares descriptions of possible video sequences with preferred video/TV and outputs a result reflecting the matches. The TV output selection preformed by the selection server can involve selecting one of a number of alternative sequences or selecting a combination of sequences constituting all or a subset of the alternative sequences. In the illustrated example, there are four possible sequences, three of which matching the preferences of the user and being combined into an appropriately composed video output stream.

After the output decision, the selection server 120 instructs the video system 110 on what television/video content to output for the mobile terminal 130 (V) and the video system sends a corresponding video stream to the mobile terminal (VI). In a preferred embodiment, IMS (IP Multimedia Subsystem) [2] is used for the control of media streams to mobile devices.

As a consequence of the adaptation of television content according to user preferences, the invention may involve parallel display of several event streams on several devices. It for example enables personalized television services, such that when a user watches a program, he can see the same program from different angles on his different devices. In addition, when there is e.g. an interruption for advertising in one display, the story can continue in another display. This implies that the user for example can watch the same story unfold on his television set and his mobile, but from the point of view of different characters; and when there is an advertising break on the television set, the user will get a few extra minutes of action on his mobile. The service may be a subscription service, since the mobile has an individual identity.

Determining Main Output Sequence by Voting

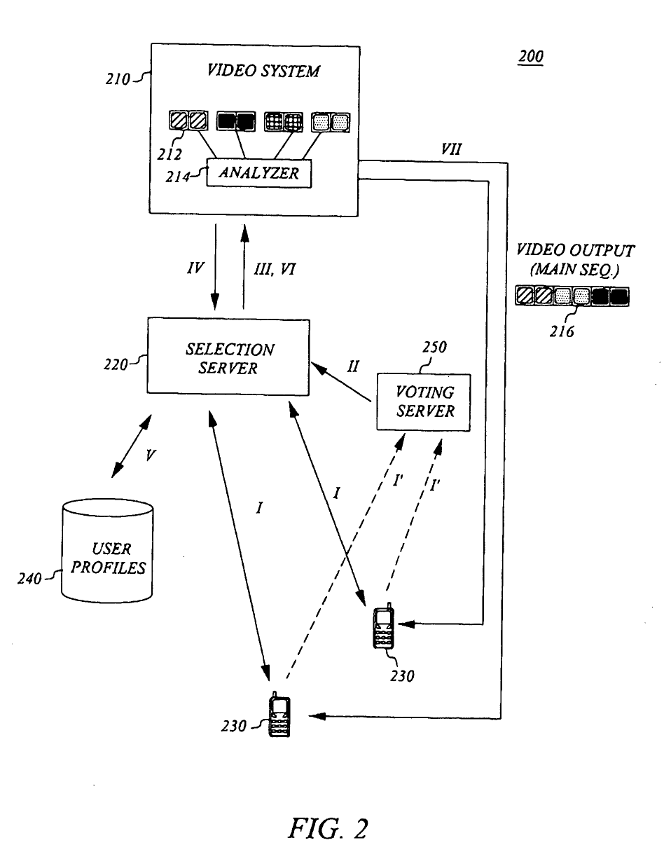

In accordance with another embodiment of the present invention, the proposed mechanism for selecting television content is used to select main (i.e. default) sequence based on user votes. During the individual breaks, the user will be confronted with selections, which will drive the actions of the characters on the main screen, and in subsequent individual episodes. FIG. 2 is a schematic overview of such a network for mobile television communication, in which the users can vote to direct the action in accordance with an exemplary embodiment of the invention.

The elements of the network of FIG. 2 basically correspond to those of FIG. 1, but in FIG. 2 there is also a voting server/service 250. The voting server 250 is adapted for collecting votes of the individual mobile terminals 230 and normally comprises suitable processing means in order to determine and output voting information or results reflecting the votes of the users.

The television selection can in this case be initiated as described above (I) or by the act of voting (I′). The voting server 250 counts the votes and determines the voting result. For this, some embodiments may use a voting algorithm that is biased e.g. based on payment (in essence, allowing an auction for the content of the program). The voting server 250 communicates the voting result/information to the selection server (II), which also retrieves descriptions of possible (i.e. alternative) video sequences 212 (III, IV) and possibly also additional user preference information e.g. from the user profile holding unit 240 (V). The selection server determines the main video sequence based on the possible/alternative video sequences and the user preference information (expressed through votes and sometimes also through other choices made by or information provided by the user). Like before, the selection server 220 thereafter transmits instructions to the video system 210 reflecting the determined output video sequence (VI) and the video system sends a corresponding video stream 216 to the mobile terminals 230 (VII).

In FIG. 2, both mobile terminals 230 receive the determined main output video sequence 216. It should be noted that the video output very well may be further adapted according to the preferences of the individual users, whereby the mobile terminals receive different video sequences in parallel. A preferred embodiment of the invention combines parallel television flows with a main (normally “default”) sequence determined based on a voting process. This means that there may be embodiments that allow individual users to depart from at least a portion of the main sequence (determined by votes) and select other television compositions. There may also be embodiments where the course of action of the main sequence is determined by votes but different angles of the television event are displayed at different devices.

The proposed mechanism for selecting TV content, with parallel flows and/or features determining the main flow, is associated with a number of advantages. The system can for instance be used together with the existing production apparatus of television and movie studios. This means that the present invention is easy to implement. Changes would only be required in the technical post-processing and the script development. Moreover, the described system works for an unlimited set of display devices, as long as some of them can be individually identified, or identified as belonging to a different group from others. Another advantage is that the use of the invention is unnoticeable to a user which only watches on the main broadcast medium. It is possible to let only users which subscribe to the mobile service affect the action and thus get the added value.

Description Languages and Markup

The descriptions of the alternative video sequences used by the selection server for determining video output may be written in any appropriate language. Preferably, they are based on an Extensible Markup Language (XML) language designed for scene description and/or semantic analysis. Use of XML-based languages implies that the vocabularies and formats for the language can be retrieved upon request and analyzed.

The video sequence descriptions output from the video system are typically based on a markup language, such as MPEG-7 [3]. Other possible markup languages include Hytime and Å (awe) [4]. The video sequence is “marked up” and thus described step by step by so-called metadata. The present invention provides for a new way of utilizing this markup information (metadata).

Although the selection server can be capable of handling descriptions in MPEG-7, for example, it is preferred that the selection server has access to sequence descriptions in a format suitable for automated decision making. Such descriptions can for instance be based on a semantic web technology, such as an ontology language like OWL (Ontology Web Language) [5] or DAML-S (Darpa Agent Markup Language—Services) [6]. The use of semantic web languages like OWL enable the application of artificial intelligence techniques, e.g. machine learning and automated reasoning, which facilitate personalization of the television service. In a preferred embodiment, the selection server determines the television content automatically using OWL sequence descriptions (preferably matched with user preferences expressed in OWL).

In view of the above, a particular embodiment of the invention proposes to map descriptions to the semantic web technology before using the descriptions to determine the video output. This means that content marked up with semantic information (e.g. using MPEG-7), is transformed to a format that allows for automated decision-making (e.g. OWL). The actual mapping is preferably performed before the descriptions is received at the selection server (“between” video system and selection server) but mapping functionality could also be included in the selection server.

As will be evident from the following text, it may also be advisable to perform a similar mapping of the user preference information received at the selection server in order to be able to compare video sequence descriptions to user preferences in the same format.

Multicast Groups

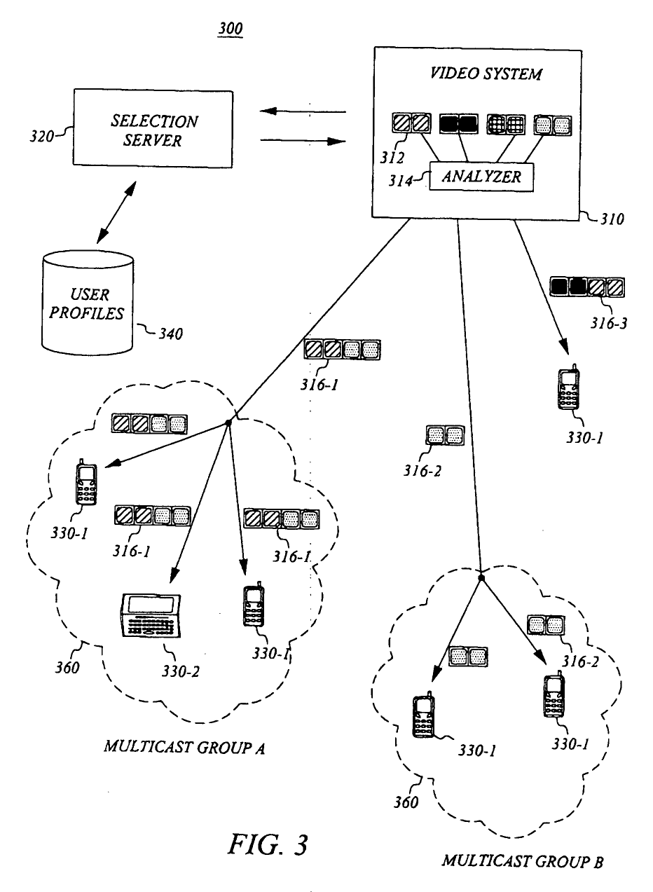

A particular embodiment of the present invention refers to a mechanism for selecting television content that is adapted for multicast scenarios. FIG. 3 is a schematic overview of such a multicast network for mobile television communication in accordance with an exemplary embodiment of the invention.

The components of the network 300 in FIG. 3 correspond to those of the network 100 in FIG. 1, but in FIG. 3 a plurality of mobile terminals 330 are shown. The mobile terminals are illustrated as mobile phones 330-1 and a laptop computer 330-2, but it is evident to the skilled person that a network according to the present invention very well may include other terminals capable of television display instead of or in addition to these exemplary terminals. The mobile terminals 330 form two multicast groups (A and B) 360, preferably associated with a respective group address. A multicast group can, with respect to transmission and content delivery, be treated basically in the same manner as a single viewer. A single stream 316-1, 316-2 is by means of the multicast technology sent from the video system 310 to multiple viewers 330 simultaneously and network resources can be saved by replicating the data at a later stage than already at the video system. The mobile terminals of the same multicast group will receive identical television content. This is illustrated in FIG. 3, where all terminals of multicast group A receive video sequence 316-1, while all terminals of multicast group B receive video sequence 316-2.

For simplicity, in FIG. 3 the communication between the respective mobile devices and the selection server has been left out. This communication may with advantage be performed via the multicast groups.

In accordance with the present invention, at least a subset of the mobile terminals 330 in the network 300 are preferably assigned to one or more multicast groups 360. The respective multicast groups 360 can either be created in advance, or at the start of the broadcast e.g. based on the description of the device received when the user accepted the notification to participate; when the user joins during the broadcast, the user can join the appropriate multicast group. The multicast group should be defined such that mobile terminals associated with the same or similar TV preferences belong to the same multicast group.

Preferably, MBMS (Multimedia Broadcast and Multicast Services) is used for the multicast communication to user terminals in accordance with the present invention. However, embodiments that use other, present or future, broadcast technologies also lie within the scope of the invention.

According to a particular advantageous embodiment, the respective mobile terminals are transferred between different multicast groups as they make new video choices. The multicast groups can be organized by the selection server, or created externally to the present system. The groups can be communicated from the selection server to an MBMS B-MSC (Broadcast Multicast Service Center) or a similar entity, which serves to organize the transmission of data in multicast scenarios.

Exemplary Applications and TV-Event

To illustrate the principles of the present invention further, exemplary applications will now be described with reference to a fictive TV-event.

Assume that two users, Alice and Bob, are watching the soap opera “Mother Knows Least” together. In the soap opera, two characters, “Mother” and “Cecilia” discuss the possibility of acquiring a new boyfriend for Cecilia. Alice and Bob see the same thing on the television screen (since the story is broadcast), but when there is an advertising break on the television screen, the following happens, Alice, who subscribes to a group which appreciates Mother, gets an inner monologue of the Mother character on the display of her mobile phone. At the end of the monologue, Alice is presented with a choice to vote on whether Mother should continue arguing with Cecilia, or whether they should go shopping. Bob, who subscribes to a group which appreciates Cecilia, gets an inner monologue of the Cecilia character on his mobile phone. At the end of the monologue, Bob is presented with a choice to vote on whether Cecilia should continue arguing with Mother, or whether they should go shopping. Neither Alice or Bob would have to subscribe in advance.

Alice and Bob both vote that the characters are to go shopping. The selection is displayed on the screen of the mobile devices, and the action on the television screen continues with the characters stopping arguing, embracing, and going shopping. To a user who watches only on the main screen, it appears as though the action continues seamlessly with the characters making up and going shopping.

A system that provides for this kind of personalized mobile television can for example work as follows. (It is assumed that the media stream or programming is sent through a central location where the processing is done, the central location typically being co-located with the video system. The displays communicate with the central location.)

In the pre-production of the show “Mother Knows Least” of the above example, the following sequences are produced:
The initial sequence, which is the same for fans of “Mother” and “Cecilia”.
The inner monologue of “Mother”, when the camera views “Cecilia”.
The inner monologue of “Cecilia”, when the camera views “Mother”.
The continuation of the argument.
The characters go shopping.

The sequences are preferably marked up (e.g. using MPEG-7) with appropriate markup which relates to the characters. The length of the advertising break and the length of the alternative action are synchronized in production. The synchronization is facilitated by the fact that advertising normally is sold in standard lengths, e.g. 30 seconds, 2 minutes, and so on.

As multiple media displays are involved, the display of the programming should be synchronized. This implies that the clocks of the terminals should be synchronized.

As starting point, the mobile phone displays the same main media stream as the television set. When the advertising break begins, a notification is sent to the user of the mobile phone, while advertising is displayed on the television set. There can be different types of notifications, for example depending on which multicast group the user belongs to. A first type may be a generic notification triggered by the initial subscription to the stream for the program by the user. It asks which of the sub-streams the user wants to watch (in the example above, “Mother”, “Cecilia”, or Advertising). This type of notification has to be accepted by the user, otherwise the same media stream as on the television set is displayed. The notification could be displayed on top of this media stream. A second type of notification depends on the previous actions of the user. It can either be triggered by the user actively subscribing to the service in advance, or by the user previously responding to the first type of notification. According to some embodiments, a user agent in the mobile device automatically responds to this notification.

The acceptance of the notification is received by an application server (the selection server), which directs the appropriate media stream to the user, or, in a multicast scenario, allocates the user to the appropriate multicast group. For acceptance of either type of notification, the user can with advantage be charged using the IMS system, according to a standardized procedure that will not be described further herein.

The users who accepted notifications receive a notification to vote with regard to the alternative sequences listed above. The vote notifications are pre-structured during the production process. The respective votes are preferably sent to the application server using IMS. This can for example be done using SIP (Session Initiation Protocol) Message [7]. Upon receipt of the votes of the users at the application server, the votes are tallied. The algorithm could be biased e.g. based on payment; and the result is matched to the appropriate media stream using the markup (here exemplified as MPEG-7). This could be realized according to the following procedure:

(i) The MPEG-7 markup is transformed to an OWL description. This can be done in advance. The resulting description of the subsequent video stream (the following scene) can for example comprise something like the following for the two alternatives:

“Mother”+“Cecilia” “Together in kitchen; talking in high voices”
“Mother”+“Cecilia” “Leave house”
   (ii) The voting result is transformed to an OWL description, which, assuming more users voted for shopping than arguing, may contain something like:
“Mother”+“Cecilia” “Leave house”
   (iii) The OWL description of the voting result and the OWL description of the video streams (scenes) are matched.
   (iv) The resulting sequence is displayed on the television set and the mobile telephone(s). Transcoding of the content to the appropriate devices can be done at the central location (or elsewhere). The transcoded content can be sent to a multicast group and/or directly to individual devices.

In the above system, only two device types (“television set” and “mobile phone”) are described, but it is to be understood that the system very well can be used with an arbitrary number of display types. A user who wants to watch both Mother and Cecilia can for example have two mobile phones.

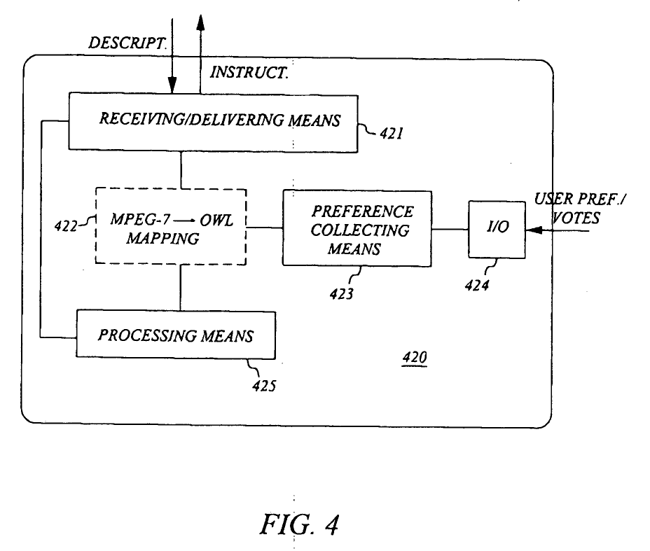

FIG. 4 is a schematic block diagram of a selection server in accordance with an exemplary embodiment of the present invention. The illustrated selection server (service) 420 comprises receiving and delivering means 421, means 423 for collecting user preferences, an interface 424 to external nodes used in collecting the user preferences, and processing means 425. The communication with the video output system occurs via the receiving and delivering means 421, which is adapted for receiving descriptions of possible video sequences related to particular television events and also for delivering instructions on what television content to output as main sequence and/or address to a particular terminal/group of terminals. The illustrated selection server further comprises optional means 422 for mapping the descriptions and/or user preferences into a semantic web technology, such as OWL. The descriptions and user preferences (transformed or not) are transferred to the processing means 425. The processing means 425 is capable of automatically determining/selecting video output based on the received information. It returns instructions for the video system to the receiving/delivering means 421. The processing means 425 preferably includes means (not shown) for comparing and mapping descriptions to user preference information and may also include appropriate translation means if needed e.g. in order to read the descriptions.

A selection server/service in accordance with the present invention may be implemented either as a separate network node or together with (i.e. included in) a video node or another network node.

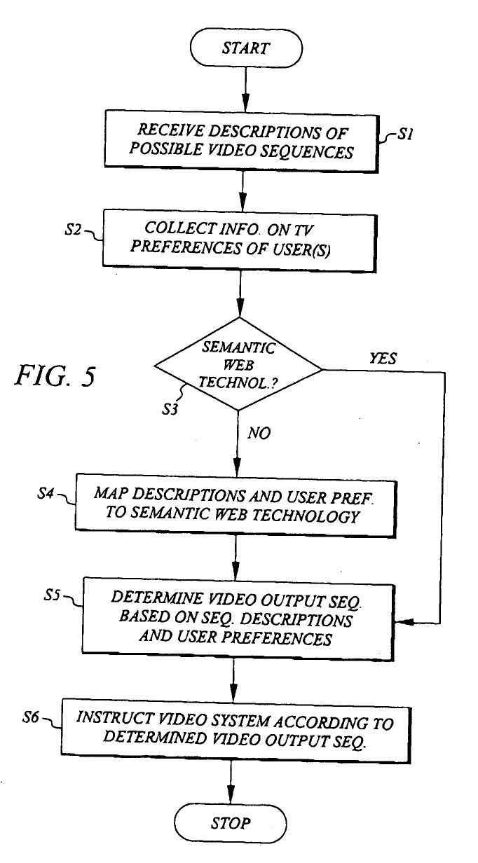

FIG. 5 is a flow chart summarizing a method for selecting television content for at least one mobile terminal in a mobile television communication system according to an exemplary embodiment of the present invention. In a first step S1, descriptions of a number of alternative video sequences of a video system is received at a selection server or service in the communication system. The alternative video sequences represent possible video sequences and are predefined and related to the same television event. Furthermore, the selection server collects information on user preferences with regard to television, the user preference information including information on user preferences associated with the at least one mobile terminal of the communication system (step S2). The user preferences may be preset in user personal profiles, or provided e.g. upon request. In a particular embodiment the user preference information is expressed through the user vote(s) in a voting process related to the television event. The system (e.g. the selection server) then invites the mobile terminals to vote on one of the alternative video sequences, collects voting information reflecting votes of the mobile terminals, and selects the main or default output video sequence among the alternative video sequences based on the voting information.

Steps S3 and S4 are optional and relate to the format of the video sequence descriptions (from step S1) and the user preference information (from step S2) Step S3 asks if this video sequence and user preference information is already expressed using a semantic web technology. If not, it is mapped to such a technology, for example OWL, in step S4 before proceeding to step S5. A preferred embodiment involves mapping from MPEG-7 to OWL. On the other hand, if the descriptions and user preferences are already in OWL or a corresponding language, the procedure goes directly from step S3 to step S5. In step S5, the selection server uses the descriptions of the alternative video sequences (from step S1 or S4) and the user preference information (from step S2 or S4) to determine an output video sequence for the at least one mobile terminal in the communication system. The output video sequence may relate the preferences of a group of users, such as a main or default output video sequence determined by voting or an output video sequence for a multicast group, or it may be entirely user-specific. In a final step S6, the selection server transmits instructions on television/video output to the video output system. These instructions correspond to the output video sequence from step S5. The instructions may be direct instructions telling the video system what video sequence(s) to output, but could also indirectly reflect the determined output video sequence for instance through the choice of multicast group for the user.

Although the invention has been described with reference to specific illustrated embodiments, it should be emphasized that it also covers equivalents to the disclosed features, as well as modifications and variants obvious to a man skilled in the art. Thus, the scope of the invention is only limited by the enclosed claims.

### Abbreviations

DAML-S Darpa Agent Markup Language—Services

IMS IP Multimedia Subsystem

MBMS Multimedia Broadcast and Multicast Services

MPEG Moving Pictures Expert Group

OWL Ontology Web Language

SIP Session Initiation Protocol

XML Extensible Markup Language

### REFERENCES

[1] “Multimedia Broadcast/Multicast Service: Architecture and Functional Description”, 3GPP TS 23.246 v6.7.0, 2005-06
[2] “IP Multimedia subsystem (IMS)”, 3GPP TS 23.228 v6. 10.0, 2005-06
[3] J. M. Martinez (ed.), MPEG-7 Overview (version 10), ISO/IEC JTC1/SC29/WG11 N6828, October 2004.
[4] K. Ø. Arisland, S. Johansen, G. Rønning, “Introducing CandleWeb and Å (awe), bringing animation power to the World Wide Web”, 1995.
[5] D. L. McGuinness and F. van Harmelen (ed.), “OWL Web Ontology Language Overview”, W3C Recommendation, Feb. 10, 2004.
[6] “DAML-S: Semantic Markup for Web Services”, white paper and DAML-S v0.9, 2003-05 at http://www.damL.org/services/owls/
[7] J. Rosenberg, H. Schulzrinne, et. al., “SIP: Session Initiation Protocol”, RFC 3261, June 2002.

1. A method for selecting television content in a digital mobile television communication system including a video output system and at least one mobile terminal, comprising the steps of:
receiving, at a selection server in the communication system, descriptions of a number of alternative video sequences of the video system, said alternative video sequences being predefined and related to the same television event;
collecting, by the selection server, information on user preferences, including user preferences associated with the at least one mobile terminal;
determining, at the selection server, an output video sequence for the at least one mobile terminal based on the descriptions of the alternative video sequences and the user preference information; and
transmitting, from the selection server to the video output system, instructions reflecting the determined output video sequence.

2. The method of claim 1, wherein the determining step involves determining an output video sequence for at least one individual mobile terminal, or group of terminals, enabling display of different video sequences at different terminals.

3. The method of claim 1, wherein the instructions to the video output system are such that the video output system will output parallel flows of video sequences, whereby a first output video sequence is transmitted to a first mobile terminal and a second output video sequence is transmitted to a second mobile terminal.

4. The method of claim 1, wherein the descriptions of the alternative video sequences used in the determining step are based on an XML (Extensible Markup Language) language designed for scene description or semantic analysis.

5. The method of claim 4, wherein the descriptions of the alternative video sequences used in the determining step are based on a semantic web technology.

6. The method of claim 5, comprising the step of mapping descriptions of alternative video sequences to the semantic web technology before using the descriptions in the determining step.

7. The method of claim 1, comprising the step of mapping user preference information to a semantic web technology before using the user preference information in the determining step.

8. The method of claim 4, wherein the descriptions of the alternative video sequences used in the determining step are based on a markup language.

9. The method of claim 1, wherein the determining step involves setting a main output video sequence.

10. The method of claim 9, in a communication system comprising a plurality of mobile terminals, further comprising the steps of:
inviting the mobile terminals to vote on one of the alternative video sequences;
collecting voting information reflecting votes of the mobile terminals; and
selecting the main output video sequence among the alternative video sequences based on the voting information.

11. The method of claim 1, in a communication system comprising a plurality of mobile terminals, further comprising the step of assigning at least a subset of the mobile terminals to one or more multicast groups, such that mobile terminals associated with the same or similar television preferences belong to the same multicast group.

12. The method of claim 11, wherein the respective mobile terminals are transferred between different multicast groups as they make new video choices.

13. A selection server with means for selecting television content in a mobile television communication system also including a video output system and at least one mobile terminal, comprising:
means for receiving descriptions of a number of alternative video sequences of the video system, said alternative video sequences being predefined and related to the same television event;
means for collecting information on user preferences, including user preferences associated with the at least one mobile terminal;
means for determining an output video sequence for the at least one mobile terminal based on the descriptions of the alternative video sequences and the user preference information; and
means for transmitting instructions that reflects the determined output video sequence to the video output system.

14. The selection server of claim 13, wherein the means for determining is arranged for determining an output video sequence for at least one individual mobile terminal, or group of terminals, enabling display of different video sequences at different terminals.

15. The selection server of claim 13, wherein the instructions to the video output system are such that the video output system will output parallel flows of video sequences, whereby a first output video sequence is transmitted to a first mobile terminal and a second output video sequence is transmitted to a second mobile terminal.

16. The selection server of claim 13, wherein the descriptions of the alternative video sequences used by the means for determining are based on an XML language designed for scene description or semantic analysis.

17. The selection server of claim 16, wherein the descriptions of the alternative video sequences used by the means for determining are based on a semantic web technology.

18. The selection server of claim 17, comprising means for mapping descriptions of alternative video sequences to the semantic web technology before using the descriptions in the determining step.

19. The selection server of claim 13, comprising means for mapping user preference information to a semantic web technology before using the user preference information in the determining step.

20. The selection server of claim 16, wherein the descriptions of the alternative video sequences used by the means for determining are based on a markup language.

21. The selection server of claim 13, wherein the means for determining is arranged for setting a main output video sequence.

22. The selection server of claim 21, in a communication system comprising a plurality of mobile terminals, further comprising:
means for inviting the mobile terminals to vote on one of the alternative video sequences; and
means for selecting the main output video sequence among the alternative video sequences based on votes of the mobile terminals.

23. The selection server of claim 13, in a communication system comprising a plurality of mobile terminals, further comprising means for assigning at least a subset of the mobile terminals to one or more multicast groups, such that mobile terminals associated with the same or similar television preferences belong to the same multicast group.

24. The selection server of claim 23, comprising means for transferring the respective mobile terminals between different multicast groups as they make new video choices.

25. A mobile/digital television communication system with means for selecting television content comprising the selection server of claim 13.
